(19) United States
(12) Patent Application Publication
(10) Pub. No.: US 2026/0292664 A1
(43) Pub. Date: Sep. 24, 2026

(54) AMBIENT POWER DEVICE FRAMES FOR WIRELESS COMMUNICATIONS

(71) Applicant: QUALCOMM Incorporated, San Diego, CA (US)

(72) Inventors: Alfred ASTERJADHI, San Diego, CA (US); Sanket Sanjay KALAMKAR, San Diego, CA (US); George CHERIAN, San Diego, CA (US)

(21) Appl. No.: 19/084,599

(22) Filed: Mar. 19, 2025

(51) Int. Cl. H04W 48/16; H02J 50/00; H04L 1/1607; H04L 5/00

(52) U.S. Cl. CPC H04W 48/16; H04L 1/1614; H04L 5/0005; H04L 5/0055; H02J 50/001

(57) ABSTRACT

This disclosure provides methods, components, devices and systems for ambient power device frames for wireless communications. Some aspects more specifically relate to an ambient power (AMP) trigger frame, to an AMP acknowledgement (Ack) frame, or both frame structures. For example, a wireless device may receive or otherwise obtain a packet that includes a plurality of fields. Field(s) in the plurality of fields may include information that identifies the packet as an AMP packet (e.g., an AMP physical layer protocol data unit (PPDU) packet) and identify at least one of a transmitter identifier, receiver identifier, or both. In some aspects, AMP packets may be associated with wireless communications by wireless devices using ambient power. The wireless device may transmit or otherwise output a response packet associated with the AMP packet. The response packet may be an AMP packet or a non-AMP packet.

### TECHNICAL FIELD

This disclosure relates generally to wireless communication and, more specifically, to ambient power device frames for wireless communications.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

In some wireless communication networks, the network may use various frame types or structures when communicating information between wireless devices. Each frame type or structure may be configured to carry or otherwise convey information tailored to support the different device types or operations. However, such wireless networks may not include or support frame types or structures that support all device types or functions. As one example, an ambient power (AMP) device may be deployed within such wireless networks to perform or otherwise support AMP operations. The AMP operations may include an AMP device that is configured as an energy harvesting capable device that uses radio frequency (RF) energy (or other energy source, such as solar, wind, etc.) to provide power to the AMP device. Such wireless networks may not generally provide or support frame types or structures that support the AMP devices.

Various aspects relate generally to a frame structure for use by AMP devices within a wireless network. Some aspects more specifically relate to an AMP trigger frame, to an AMP acknowledgement (Ack) frame, or frame structures for both the AMP trigger frame and the AMP Ack frame. In some examples, aspects of the techniques described herein provide an AMP frame type or structure to be used for wireless communications relating to AMP device related operations or functions. For example, a wireless device may receive or otherwise obtain a packet that includes a plurality of fields. Field(s) in the plurality of fields may include information that identifies the packet as an AMP packet (e.g., an AMP physical layer protocol data unit (PPDU) packet) and identify at least one of a transmitter identifier, receiver identifier, or both. In some aspects, AMP packets may be associated with wireless communications by wireless devices using ambient power. The wireless device may transmit or otherwise output a response packet associated with the AMP packet. The response packet may be an AMP packet (e.g., an AMP trigger packet or an AMP Ack packet) or a non-AMP packet (e.g., RF signals used for energy generation).

A method for wireless communications by a wireless device is described. The method may include receiving, at the wireless device, a packet that includes a set of multiple fields, where one or more fields in the set of multiple fields includes information that identifies the packet as an AMP packet and identifies at least one of a transmitter identifier, receiver identifier, or both, and where AMP packets are associated with wireless communications by wireless devices using ambient power and transmitting, by the wireless device, a response packet associated with the AMP packet.

A wireless device for wireless communications is described. The wireless device may include a processing system that includes processor circuitry and memory circuitry that stores code. The processing system may be configured to cause the wireless device to receive, at the wireless device, a packet that includes a set of multiple fields, where one or more fields in the set of multiple fields includes information that identifies the packet as an AMP packet and identifies at least one of a transmitter identifier, receiver identifier, or both, and where AMP packets are associated with wireless communications by wireless devices using ambient power and transmit, by the wireless device, a response packet associated with the AMP packet.

Another wireless device for wireless communications is described. The wireless device may include means for receiving, at the wireless device, a packet that includes a set of multiple fields, where one or more fields in the set of multiple fields includes information that identifies the packet as an AMP packet and identifies at least one of a transmitter identifier, receiver identifier, or both, and where AMP packets are associated with wireless communications by wireless devices using ambient power and means for transmitting, by the wireless device, a response packet associated with the AMP packet.

A non-transitory computer-readable medium storing code for wireless communications is described. The code may include instructions executable by one or more processors to receive, at the wireless device, a packet that includes a set of multiple fields, where one or more fields in the set of multiple fields includes information that identifies the packet as an AMP packet and identifies at least one of a transmitter identifier, receiver identifier, or both, and where AMP packets are associated with wireless communications by wireless devices using ambient power and transmit, by the wireless device, a response packet associated with the AMP packet.

In some examples of the method, wireless devices, and non-transitory computer-readable medium described herein, the one or more fields include information identifying an AMP packet type associated with the AMP packet, the AMP packet type including at least one of an AMP trigger packet or an AMP acknowledgement packet.

In some examples of the method, wireless devices, and non-transitory computer-readable medium described herein, the AMP packet includes an AMP trigger packet configured to request the response packet.

In some examples of the method, wireless devices, and non-transitory computer-readable medium described herein, the AMP trigger packet includes a bitmap that may be set to a value to request the response packet and the response packet may be transmitted according to the value.

In some examples of the method, wireless devices, and non-transitory computer-readable medium described herein, the AMP packet includes both the transmitter identifier and the receiver identifier.

In some examples of the method, wireless devices, and non-transitory computer-readable medium described herein, the AMP packet includes access policy and distribution information associated with time resources, frequency resources, or both, for the response packet.

In some examples of the method, wireless devices, and non-transitory computer-readable medium described herein, the response packet includes an AMP acknowledgment packet.

In some examples of the method, wireless devices, and non-transitory computer-readable medium described herein, the AMP packet includes an AMP acknowledgement packet configured to request the response packet.

Some examples of the method, wireless devices, and non-transitory computer-readable medium described herein may further include operations, features, means, or instructions for transmitting a second response packet prior to receiving the AMP acknowledgement packet, where the AMP acknowledgement packet may be received based on the second response packet.

In some examples of the method, wireless devices, and non-transitory computer-readable medium described herein, the response packet includes additional signaling associated with at least one of wireless device charging, one or more AMP trigger packets, instructions relating to additional communications, or any combination thereof.

In some examples of the method, wireless devices, and non-transitory computer-readable medium described herein, the AMP acknowledgment packet includes the receiver identifier and omits the transmitter identifier.

In some examples of the method, wireless devices, and non-transitory computer-readable medium described herein, the AMP acknowledgement packet includes wakeup information associated with activating one or more radios of the wireless device.

In some examples of the method, wireless devices, and non-transitory computer-readable medium described herein, the AMP acknowledgement packet includes a payload field indicating at least one of data, control information, management information, or any combination thereof.

In some examples of the method, wireless devices, and non-transitory computer-readable medium described herein, the AMP packet includes a request for scheduling information, a request for energy harvesting capability information, or both.

In some examples of the method, wireless devices, and non-transitory computer-readable medium described herein, the AMP packet includes a request for identifier information associated with the wireless device.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows a pictorial diagram of another example wireless communication network.

FIG. 3 shows an example of a signaling diagram that supports ambient power device frames for wireless communications.

FIG. 4 shows an example of an ambient power (AMP) packet that supports ambient power device frames for wireless communications.

FIG. 5 shows an example of an AMP packet that supports ambient power device frames for wireless communications.

FIG. 6 shows a block diagram of an example wireless communication device that supports ambient power device frames for wireless communications.

FIGS. 7 and 8 show flowcharts illustrating example processes performable by or at a wireless device that supports ambient power device frames for wireless communications.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

In some wireless communication networks, the network may use various frame types or structures when communicating information between wireless devices. Each frame type or structure may be configured to carry or otherwise convey information tailored to support the different device types or operations. However, such wireless networks may not include or support frame types or structures that support all device types or functions. As one example, an ambient power (AMP) device may be deployed within such wireless networks to perform or otherwise support AMP operations. The AMP operations may include an AMP device that is configured as an energy harvesting capable device that uses radio frequency (RF) energy (or other energy source, such as solar, wind, etc.) to provide power to the AMP device. Such wireless networks may not generally provide or support frame types or structures that support the AMP devices.

Various aspects relate generally to a frame structure for use by AMP devices within a wireless network. Some aspects more specifically relate to an AMP trigger frame, to an AMP acknowledgement (Ack) frame, or frame structures for both the AMP trigger frame and the AMP Ack frame. In some examples, aspects of the techniques described herein provide an AMP frame type or structure to be used for wireless communications relating to AMP device related operations or functions. For example, a wireless device may receive or otherwise obtain a packet that includes a plurality of fields. Field(s) in the plurality of fields may include information that identifies the packet as an AMP packet (e.g., an AMP physical layer protocol data unit (PPDU) packet) and identify at least one of a transmitter identifier, receiver identifier, or both. In some aspects, AMP packets may be associated with wireless communications by wireless devices using ambient power. The wireless device may transmit or otherwise output a response packet associated with the AMP packet. The response packet may be an AMP packet (e.g., an AMP trigger packet or an AMP Ack packet) or a non-AMP packet (e.g., RF signals used for energy generation).

Particular aspects of the subject matter described in this disclosure can be implemented to realize one or more of the following potential advantages. In some examples, by providing for the packet frame formatting described herein, the described techniques can be used to enable AMP-specific operations within the wireless network. The AMP frame structure may provide a mechanism for supporting various operations, functions, or communication types for AMP devices, such as AMP-specific information, continuous wave (CW) charging signal transmissions, or other operations that improve AMP device wireless communications within a wireless network.

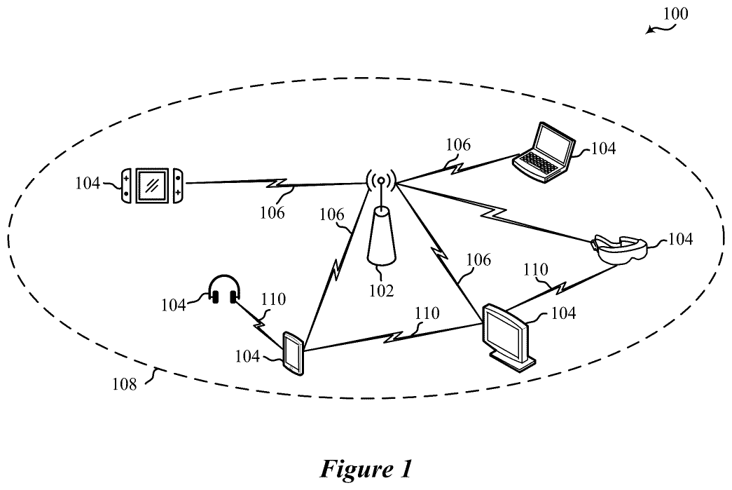

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the 802.11bq Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (for example, in an extended service set (ESS) deployment, enterprise network or AP mesh network), or may not include any AP at all (for example, in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (for example, a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (for example, for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (for example, UHR-or IEEE 802.11bn-compatible) devices for opportunistic access to spectrum that may be otherwise under-utilized.

Puncturing is a wireless communication technique that enables a wireless communication device (such as either an AP 102 or a STA 104) to transmit and receive wireless communications over a portion of a wireless channel exclusive of one or more particular subchannels (hereinafter also referred to as “punctured subchannels”). Puncturing specifically may be used to exclude one or more subchannels from the transmission of a PPDU, including the signaling of the preamble, to avoid interference from a static source, such as an incumbent system, or to avoid interference of a more dynamic nature such as that associated with transmissions by other wireless communication devices in overlapping BSSs (OBSSs). The transmitting device (such as an AP 102 or a STA 104) may puncture the subchannels on which there is interference and in essence spread the data of the PPDU to cover the remaining portion of the bandwidth of the channel. For example, if a transmitting device determines (for example, detects, identifies, ascertains, or calculates), in association with a contention operation, that one or more 20 MHz subchannels of a wider bandwidth wireless channel are busy or otherwise not available, the transmitting device implement puncturing to avoid communicating over the unavailable subchannels while still utilizing the remaining portions of the bandwidth. Accordingly, puncturing enables a transmitting device to improve or maximize throughput, and in some instances reduce latency, by utilizing as much of the available spectrum as possible. Static puncturing in particular makes it possible to consistently use wideband channels in environments or deployments where there may be insufficient contiguous spectrum available, such as in the 5 GHz and 6 GHz bands.

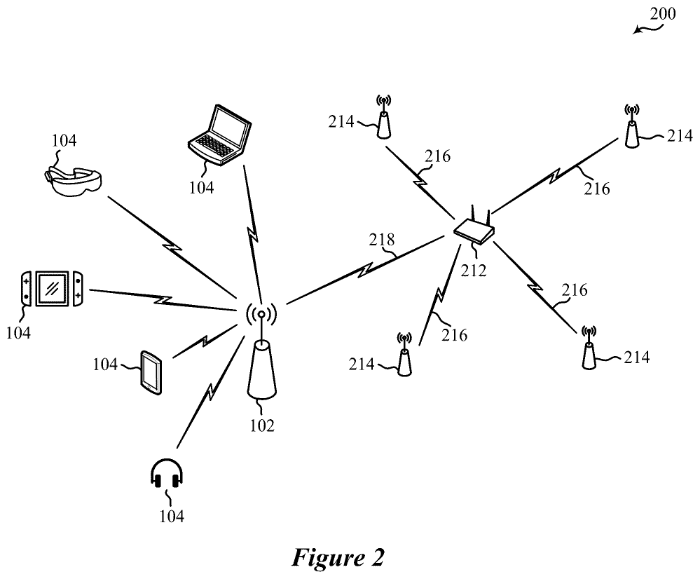

FIG. 2 shows a pictorial diagram of another example wireless communication network 200. According to some aspects, the wireless communication network 200 can be an example of a mesh network, an IoT network, or a sensor network in accordance with one or more of the IEEE 802.11 family of wireless communication protocol standards (including the 802.11ah amendment). The wireless communication network 200 may include multiple wireless communication devices 214, which in some implementations may include APs 102, STAs 104, or both. The wireless communication devices 214 may represent various devices such as display devices (for example, TVs, computer monitors, navigation systems, among others), music or other audio or stereo devices, remote control devices (“remotes”), printers, kitchen or other household appliances, among other examples. In some examples, the wireless communication devices 214 may represent an example of an AMP device that is configured to or otherwise operations using ambient power. For example, the wireless communication devices 214 may be an example of an AMP reader device that provides wireless signals to power and to communicate with an AMP tag device. The AMP tag device may use the wireless signals for operational power as well as for communicating with the AMP reader device.

In some examples, the wireless communication devices 214 sense, measure, collect or otherwise obtain and process data and transmit such raw or processed data to an intermediate device 212 for subsequent processing or distribution. Additionally, or alternatively, the intermediate device 212 may transmit control information, digital content (for example, audio or video data), configuration information or other instructions to the wireless communication devices 214. The intermediate device 212 and the wireless communication devices 214 can communicate with one another via wireless communication links 216. In some examples, the wireless communication links 216 include Bluetooth links or other PAN or short-range communication links.

In some examples, the intermediate device 212 also may be configured for wireless communication with other networks such as with a WLAN or a wireless (for example, cellular) wide area network (WWAN), which may, in turn, provide access to external networks including the Internet. For example, the intermediate device 212 may associate and communicate, over a Wi-Fi link 218, with an AP 102 of a wireless communication network 200, which also may serve various STAs 104. In some examples, the intermediate device 212 is an example of a network gateway, for example, an IoT gateway. In such a manner, the intermediate device 212 may serve as an edge network bridge providing a Wi-Fi core backhaul for the IoT network including the wireless communication devices 214. In some examples, the intermediate device 212 can analyze, preprocess and aggregate data received from the wireless communication devices 214 locally at the edge before transmitting it to other devices or external networks via the Wi-Fi link 218. The intermediate device 212 also can provide additional security for the IoT network and the data it transports.

Aspects of transmissions may vary according to a distance between a transmitter (for example, an AP 102 or a STA 104) and a receiver (for example, another AP 102 or STA 104). Wireless communication devices (such as the AP 102 or the STA 104) may generally benefit from having information regarding the location or proximities of the various STAs 104 within the coverage area. In some examples, relevant distances may be determined (for example, calculated or computed) using RTT-based ranging procedures. Additionally, in some examples, APs 102 and STAs 104 may perform ranging operations. Each ranging operation may involve an exchange of fine timing measurement (FTM) frames (such as those defined in the 802.11az amendment to the IEEE family of wireless communication protocol standards) to obtain measurements of RTT transmissions between the wireless communication devices.

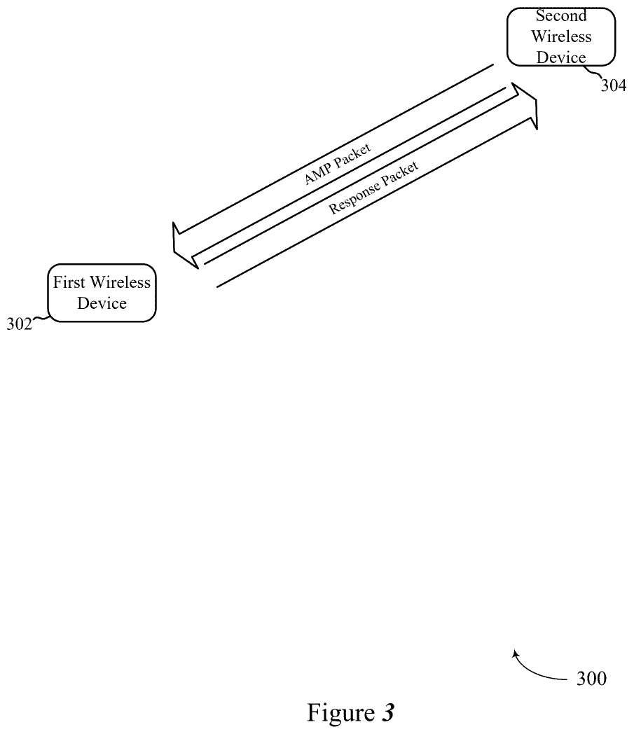

FIG. 3 shows an example of a signaling diagram 300 that supports ambient power device frames for wireless communications. Aspects of the signaling diagram 300 may be implemented at or implemented by aspects of the wireless communication network 100 or the wireless communication network 200. Aspects of the signaling diagram 300 may be implemented at or implemented by a first wireless device 302 and a second wireless device 304, which may be examples of the corresponding devices described herein. For example, aspects of the first wireless device 302, the second wireless device 304, or both devices may be examples of a STA 104 or an AP 102 as discussed with reference to FIGS. 1 and 2. In some aspects, the first wireless device 302, the second wireless device 304, or both devices may be associated with or otherwise support AMP-based communications within a wireless network.

Wireless networks generally support various communication types and functions. This may include traditional communication types, such as video streaming, audio calls, and the like, as well as other communication types, such as small data communications (e.g., sensors), uplink heavy traffic, downlink heavy traffic, and the like. Each communication type may be associated with various functions, requirements, considerations, and other factors. For example, things such as latency, reliability, purpose/function, user experience, and other factors may be more applicable to some communication types than other types of communications. Some such factors may be unique to certain communication types while being not applicable to other communication types.

To support such varying communication types, wireless networks may use various frame structures (e.g., PPDU packet formatting). Each frame structure or packet format may include some fields that are unique to the associated communication type, which may not be relevant or applicable to other communication types. The fields included in a particular frame format may be selected or configured to convey both explicit information as well as implicit information. For example, some implicit information can be applicable to and understood by a certain wireless device (e.g., an IoT device) that would be inapplicable to or lost to a different type of wireless device (e.g., an advanced STA). However, not all wireless networks define a frame format that supports every type of wireless communications or device type.

In some examples, AMP based wireless communications may include an energy harvesting capable device that relies (at least to some extent) on wireless signals to energize and provide operational power to the AMP device. Examples of such AMP devices include a reader-tag scenario, an IoT device, and other device types, where the reader transmits an energizing signal (e.g., a CW signal) to the tag. The tag may receive the energizing signal and use it to provide the power supply for the tag. The energizing signal may include information, in some cases. In some cases, the energizing signal may be a radio frequency (RF) signal provided to energize the tag. In cases where the energizing signal is an RF signal which does not include other information, another signal that carries or otherwise conveys various information (e.g., a READ command, a WRITE command, or other such information that may be specific to a tag) may be transmitted to the tag.

Accordingly, the techniques described herein provide for an AMP frame format that may be applicable within a wireless network. Aspects of the described techniques include, but are not limited to, an AMP trigger frame format, and AMP Ack frame format, or both AMP frame formats. However, it is to be understood that other AMP frame formats may be applied using the techniques described herein.

For example, the second wireless device 304 may transmit or otherwise output (and the first wireless device 302 may receive or otherwise obtain) a packet that includes a plurality of fields. One or more fields of the packet (e.g., the PPDU packet) may carry or otherwise convey information that identifies the packet as an AMP packet. The field(s) of the AMP packet may carry or otherwise convey information that identifies a type of the AMP packet, such as an AMP trigger packet or an AMP Ack packet.

In some cases, the field(s) of the packet may also carry or otherwise convey information that identifies a transmitter identifier, a receiver identifier, or both. The transmitter identifier may generally carry or otherwise convey information that indicates or otherwise identifies the device that has transmitted the packet (e.g., the second wireless device 304, in this example). The transmitter identifier may identify the source of the packet. The receiver identifier may generally carry or otherwise convey information that indicates or otherwise identifies the device that the packet is directed to (e.g., the first wireless device 302, in this example). The receiver identifier may identify the recipient of the packet.

In some cases, the field(s) of the AMP packet may be associated with wireless communications by wireless devices using ambient power. The first wireless device 302, the second wireless device 304, or both wireless devices, may perform wireless communications using ambient power. The first wireless device 302 may transmit or otherwise output (and the second wireless device 304 may receive or otherwise obtain) a response packet associated with the AMP packet. The response packet may be another AMP packet or a different signal.

In some cases, the first wireless device 302 may be an example of a reader while the second wireless device 304 may be an example of a tag (e.g., an energy harvesting capable device). In some cases, the first wireless device 302 may be an example of a tag while the second wireless device 304 may be an example of a reader. Thus, the AMP frame format associated with the AMP packet may be used for reader-to-tag communications, for tag-to-reader communications, or communications in both directions. Moreover, the response packet may be another AMP packet or may be a non-AMP packet. In some cases, the AMP packet may be received based on a previous packet transmitted by the first wireless device 302 (e.g., a second response packet).

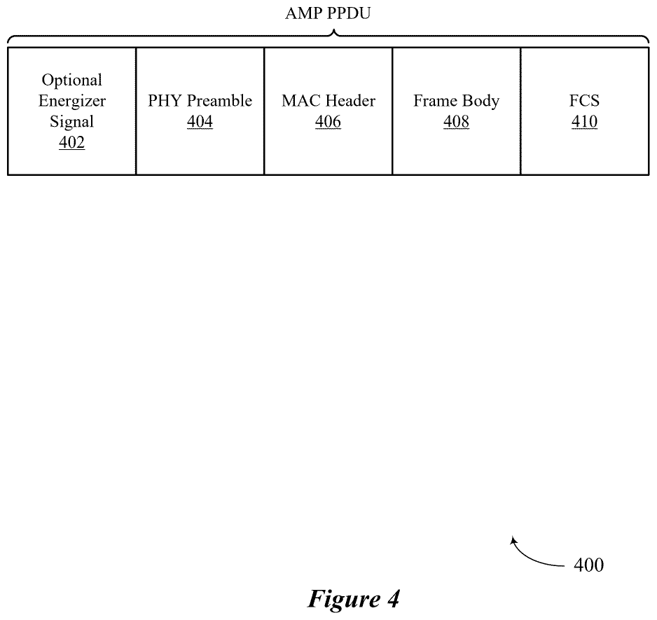

FIG. 4 shows an example of an AMP packet 400 that supports ambient power device frames for wireless communications. Aspects of the AMP packet 400 may be implemented at or implemented by aspects of the wireless communication network 100 or the wireless communication network 200 or aspects of the signaling diagram 300. Aspects of the AMP packet 400 may be implemented at or implemented by a first wireless device and a second wireless device, which may be examples of the corresponding devices described herein. For example, aspects of the first wireless device, the second wireless device, or both devices may be examples of a STA 104 or an AP 102 as discussed with reference to FIGS. 1 and 2. In some aspects, the first wireless device, the second wireless device, or both devices may be associated with or otherwise support AMP-based communications within a wireless network.

As discussed above, the techniques described herein provide for a first wireless device to transmit a packet that includes field(s) where one or more of the field(s) identifies the packet as an AMP packet. In some cases, the field(s) of the AMP packet may carry a transmitter identifier, a receiver identifier, or both identifiers. Broadly, the AMP packet may be associated with wireless communications by the wireless devices using ambient power. The first wireless device may transmit a response packet that is associated with the AMP packet. The AMP packet 400 illustrates one example of an AMP packet (e.g., an AMP PPDU frame format) according to the techniques described herein. The frame format of the AMP packets may include fields corresponding to an energizer signal 402, a PHY preamble 404, a MAC header 406, a frame body 408, and a frame check sequence (FCS) 410.

The energizer signal 402 may be optionally included in the AMP packet, may be transmitted separately from the AMP packet, or may be absent in some cases (e.g., such as when the AMP packet is a tag-to-reader packet). The energizer signal 402 may be a CW or may carry information, when included.

In some cases, the PHY preamble 404, the MAC header 406, or both fields may be an example of a frame control portion of the AMP packet. The MAC header 406 may use 32 bits, in some cases. The frame control may include or span a number of bits (e.g., eight bits or some other number of bits) that is used to carry or otherwise convey information identifying the packet as an AMP packet. For example, the frame control (e.g., the PHY preamble 404, the MAC header 406, or both fields) may carry or otherwise convey information that identifies the packet as an AMP packet. The frame control may carry or otherwise convey information that identifies or otherwise indicates the type of AMP frame or packet (e.g., an AMP trigger, an AMP Ack, etc.). In some cases, the frame control carries or otherwise conveys information that identifies or otherwise indicates whether the FCS field (e.g., the FCS 410) is included. If the FCS field is present, the frame control may carry or otherwise convey information that identifiers whether the FCS 410 carries or uses a cyclic redundancy check (CRC) or a message integrity code (MIC). In some cases, other fields may be included in the frame control.

In some cases, the frame control (e.g., the PHY preamble 404, the MAC header 406, or both fields) may be used to carry or otherwise convey the transmitter identifier, the receiver identifier, or both identifiers. Thus, the frame control may include both identifiers (e.g., possibly two identifiers with each identifier using 12 bits). This may include one identifier for the transmitter (the transmitter identifier) and one identifier for the individual recipient, or a group of recipients (e.g., the receiver identifier). In some AMP frame types, both the transmitter identifier and the receiver identifier may not be necessary. In this case, both fields may be set to a value that includes the receiver identifier or multiple receiver identifiers. In some cases, the AMP frame or packet may have an embedded identifier before the FCS 410, which may be included in the computation of the FCS but excluded from the transmission. These identifiers can be derived or otherwise determined from the transmitter's or the receiver's MAC address, or both.

In some case, the frame body 408 may be optionally present in the AMP frame or packet. This may be enabled to support variable-length PPDUs. As discussed, the FCS 410 may be optionally present and, when present, contain the CRC or the MIC. In some cases, the FCS field may use zero bits (e.g., when not present) or may use 16 bits (e.g., when present). In some cases, the FCS field may reduce the number of bits by using 4-bit CRCs or 8-bit CRCs.

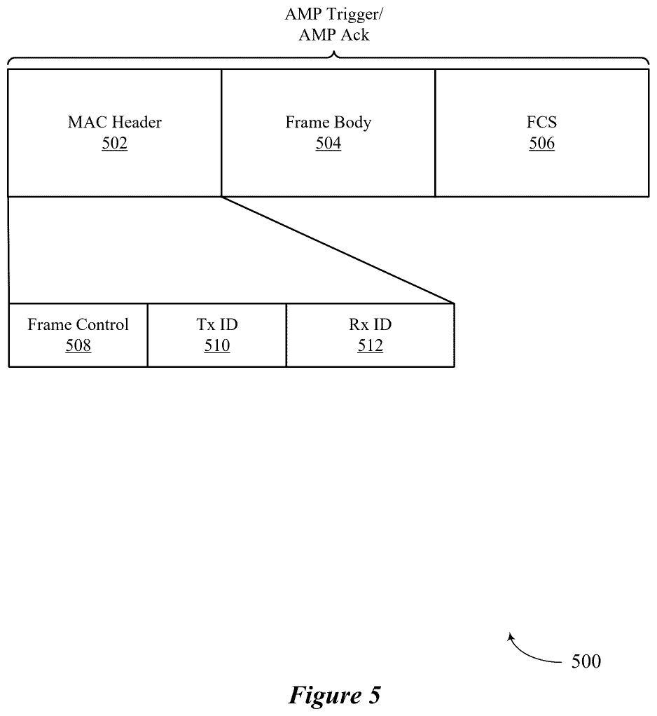

FIG. 5 shows an example of an AMP packet 500 that supports ambient power device frames for wireless communications. Aspects of the AMP packet 500 may be implemented at or implemented by aspects of the wireless communication network 100 or the wireless communication network 200 or aspects of the signaling diagram 300. Aspects of the AMP packet 500 may be implemented at or implemented by a first wireless device and a second wireless device, which may be examples of the corresponding devices described herein. For example, aspects of the first wireless device, the second wireless device, or both devices may be examples of a STA 104 or an AP 102 as discussed with reference to FIGS. 1 and 2. In some aspects, the first wireless device, the second wireless device, or both devices may be associated with or otherwise support AMP-based communications within a wireless network.

As discussed above, the techniques described herein provide for a first wireless device to transmit a packet that includes field(s) where one or more of the field(s) identifies the packet as an AMP packet. In some cases, the field(s) of the AMP packet may carry a transmitter identifier, a receiver identifier, or both identifiers. Broadly, the AMP packet may be associated with wireless communications by the wireless devices using ambient power. The first wireless device may transmit a response packet that is associated with the AMP packet. The AMP packet 500 illustrates one example of an AMP packet (e.g., an AMP PPDU frame format) according to the techniques described herein. The frame format of the AMP packets may include fields corresponding to a MAC header 502, a frame body 504, and an FCS 506.

Broadly, the AMP packet 500 illustrates an example frame format for an AMP trigger packet or for an AMP Ack packet. In this example, the MAC header 502 is used to carry or otherwise convey the frame control information (e.g., as discussed above), which includes a frame control 508, a transmitter identifier 510, and a receiver identifier 512.

Thus, in one example the AMP packet received by the first wireless device includes an AMP trigger packet. The AMP trigger packet may carry or otherwise convey information that identifies the transmitter and the receiver of the AMP trigger packet. As shown, the MAC header 502 may include the transmitter identifier 510 that includes information that at least pseudo uniquely identifies the transmitting device (e.g., an AMP AP or an AMP STA). The MAC header 502 may include the receiver identifier 512 that includes information that at least pseudo uniquely identifies the receiving device (e.g., an AMP STA or an AMP AP) or the group of receiving devices. Thus, in some cases the AMP trigger packet includes both the transmitter identifier and the receiver identifier.

In some cases, the AMP trigger packet may carry or otherwise convey information identifying an access policy for time division multiple access (TDMA), a resource distribution for frequency division multiple access (FDMA), or both, such as when a response is needed. Thus, the AMP trigger packet may include an access policy and distribution information associated with time resources, with frequency responses, or both, for the response packet provided by the first wireless device. In some cases, the AMP trigger packet may include a bit for each of the wireless devices indicating whether a response is needed or allowed in response to the AMP trigger frame. For example, the AMP packet may include a bitmap where each bit uniquely corresponds to a receiving device and the bit is set to value that indicates whether the response packet is to be transmitted. As one example, if a bit is set to “1” then STA is supposed to respond with an AMP response frame in the resource indicated in the AMP trigger packet or following the access rules that are indicated in the AMP trigger packet. Accordingly, in some cases the AMP trigger packet may be configured or otherwise serve as a request for the response packet from the first wireless device.

In some cases, the AMP trigger packet may include an association identifier (AID) list for the groupcast case, such as in the frame body 504. In some cases, the AMP trigger packet may include an indication for the receiving device(s) to acknowledge a previously sent uplink response (e.g., to support cascading sequences). Thus, in some cases the response packet associated with the AMP trigger packet may be an AMP Ack packet or a non-AMP packet.

That is, the AMP response frame can be an AMP Ack frame, which may also indicate some additional information, such as an indication that an AMP STA has pending AMP data available to send. But, to send the pending AMP data the AMP STA needs further charging, needs further triggering (e.g., an individual triggering tailored to the STA), or provides specific instructions to the AMP AP to help the AMP STA to complete subsequent AMP deliveries (schedules, etc.). Thus, the AMP Ack packet may include various additional signaling, such as a wireless device charging, AMP trigger packet(s), instructions relating to additional communications, or any combination of such additional information.

In some cases, the AMP response frame may include a wake up frame that indicates that the AMP STA is to wake its auxiliary radio or main radio, and possibly specific parameters that that auxiliary radio or main radio will use. For example, the AMP Ack packet may include wakeup information associated with the first wireless device activating one or more of its radios.

In some cases, the AMP response frame may be another AMP frame or packet that contains a payload, such as data, management or control information (e.g., sensor readings, feedback, specifics of operation, etc.), or other information. That is, the AMP Ack packet may include a payload field in some examples that indicates data, control information, management information, or other information related to AMP based wireless communications or operations. The AMP packet 500 may be used for various purposes. For example, the AMP packet 500 may be used to carry or otherwise convey a request for scheduling information from the AMP client, such as how often the AMP client wants the AMP AP or reader to trigger the AMP client for uplink data. The AMP AP or reader may also use the AMP packet 500 to carry or otherwise convey an inquiry about the client's energy harvesting capabilities, with the client providing this information in the frame body of the uplink AMP packet. While the AMP packet 500 format may be maintained, its purpose may extend beyond triggering and acknowledging. An indication in a MAC header or frame body may signify that the AMP packet 500 is requesting specific information from the AMP client.

Depending on the AMP operation phase, the AMP packet 500 may also serve different functions. As one example, initially when the AMP AP and clients are unfamiliar with each other, the AMP AP may broadcast an AMP packet to solicit MAC addresses or receiver identifiers of active AMP clients, which the clients then send in an uplink AMP packet. During the phase of exchanging detailed information (e.g., scheduling information, energy harvesting capabilities, etc.), the same downlink or uplink AMP packets may be used. When actual data communication occurs (e.g., a temperature sensor sending temperature data), the AMP packet may function as trigger and Ack.

As discussed, the AMP packet 500 also illustrates a frame format where the AMP packet received by the first wireless device is an AMP Ack frame or packet. In some aspects, the AMP Ack packet may be configured or otherwise act to request the response packet. The AMP Ack packet may be sent by one or more AMP STAs in response to an AMP trigger frame or another AMP frame that is sent by a peer STA and that AMP frame requires or otherwise requests an acknowledgment. In some cases, the AMP Ack frame may optionally identify the transmitter (e.g., the transmitter identifier 510) (not essential) and optionally identify the recipient (e.g., the receiver identifier 512). In some cases, the AMP Ack packet may include the receiver identifier 512 but omit the transmitter identifier 510. Again, the transmitter identifier may at least pseudo uniquely identifies the transmitting device (e.g., the AMP AP) and the receiver identifier may at least pseudo uniquely identify the receiving device (e.g., the AMP STA) or the group of receiving devices. In some cases, the AMP Ack packet may be configured or otherwise carry other information as well.

As discussed, the AMP Ack packet may be based on a previous uplink packet sent by the first wireless device. That is, the first wireless device may transmit a second response packet (e.g., an AMP packet or a non-AMP packet) that triggers transmission of the AMP packet. The AMP Ack packet may be transmitted based on the second response packet that was transmitted prior to the first wireless device receiving the AMP packet.

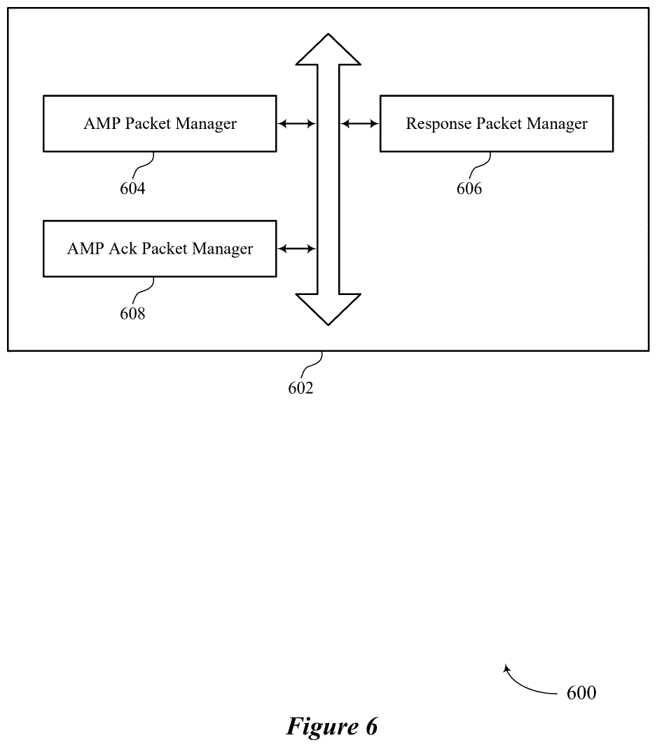

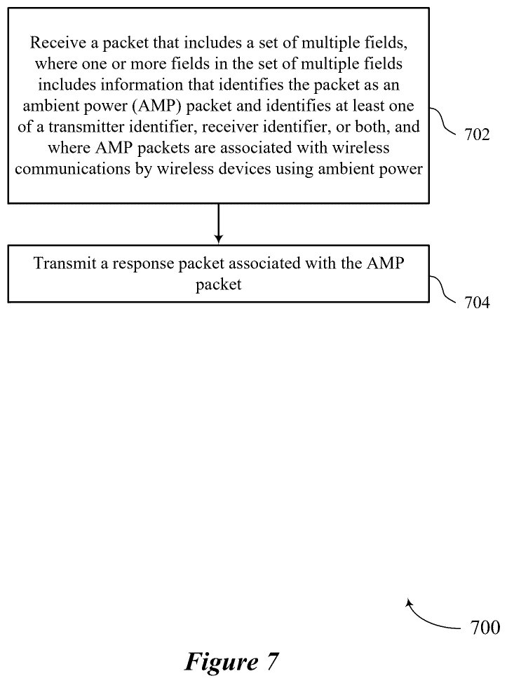

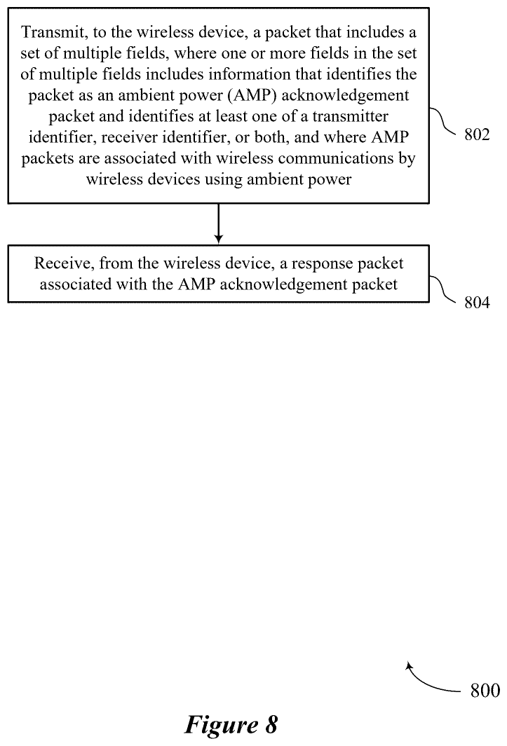

FIG. 6 shows a block diagram of an example wireless communication device 600 that supports ambient power device frames for wireless communications. In some examples, the wireless communication device 600 is configured to perform the processes 700 and 800 described with reference to FIGS. 7 and 8, respectively. The wireless communication device 600 may include one or more chips, SoCs, chipsets, packages, components or devices that individually or collectively constitute or include a processing system. The processing system may interface with other components of the wireless communication device 600, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 600 may transmit the information output from the chip. In such an example, the second interface may refer to an interface between the processing system of the chip and a reception component, such that the wireless communication device 600 may receive information that is then passed to the processing system. In some such examples, the first interface also may obtain information, such as from the transmission component, and the second interface also may output information, such as to the reception component.

The processing system of the wireless communication device 600 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 600 can be configurable or configured for use in an AP or STA, such as the AP 102 or the STA 104 described with reference to FIG. 1. In some other examples, the wireless communication device 600 can be an AP or STA that includes such a processing system and other components including multiple antennas. The wireless communication device 600 is capable of transmitting and receiving wireless communications in the form of, for example, wireless packets. For example, the wireless communication device 600 can be configurable or configured to transmit and receive packets in the form of physical layer PPDUs and MPDUs conforming to one or more of the IEEE 802.11 family of wireless communication protocol standards. In some other examples, the wireless communication device 600 can be configurable or configured to transmit and receive signals and communications conforming to one or more 3GPP specifications including those for 5G NR or 6G. In some examples, the wireless communication device 600 also includes or can be coupled with one or more application processors which may be further coupled with one or more other memories. In some examples, the wireless communication device 600 further includes a user interface (UI) (such as a touchscreen or keypad) and a display, which may be integrated with the UI to form a touchscreen display that is coupled with the processing system. In some examples, the wireless communication device 600 may further include one or more sensors such as, for example, one or more inertial sensors, accelerometers, temperature sensors, pressure sensors, or altitude sensors, that are coupled with the processing system. In some examples, the wireless communication device 600 further includes at least one external network interface coupled with the processing system that enables communication with a core network or backhaul network that enables the wireless communication device 600 to gain access to external networks including the Internet.

The wireless communication device 600 includes a communications manager 602 that includes an AMP packet manager 604, a response packet manager 606, and an AMP Ack packet manager 608. Portions of one or more of the AMP packet manager 604, the response packet manager 606, and the AMP Ack packet manager 608 may be implemented at least in part in hardware or firmware. For example, one or more of the AMP packet manager 604, the response packet manager 606, and the AMP Ack packet manager 608 may be implemented at least in part by at least a processor or a modem. In some examples, portions of one or more of the AMP packet manager 604, the response packet manager 606, and the AMP Ack packet manager 608 may be implemented at least in part by a processor and software in the form of processor-executable code stored in memory.

The wireless communication device 600 may support wireless communications in accordance with examples as disclosed herein. The AMP packet manager 604 is configurable or configured to receive, at the wireless device, a packet that includes a set of multiple fields, where one or more fields in the set of multiple fields includes information that identifies the packet as an ambient power (AMP) packet and identifies at least one of a transmitter identifier, receiver identifier, or both, and where AMP packets are associated with wireless communications by wireless devices using ambient power. The response packet manager 606 is configurable or configured to transmit, by the wireless device, a response packet associated with the AMP packet.

In some examples, the one or more fields include information identifying an AMP packet type associated with the AMP packet, the AMP packet type including at least one of an AMP trigger packet or an AMP acknowledgement packet.

In some examples, the AMP packet includes an AMP trigger packet configured to request the response packet. In some examples, the AMP trigger packet includes a bitmap that is set to a value to request the response packet. In some examples, the response packet is transmitted according to the value. In some examples, the AMP packet includes both the transmitter identifier and the receiver identifier. In some examples, the AMP packet includes access policy and distribution information associated with time resources, frequency resources, or both, for the response packet. In some examples, the response packet includes an AMP acknowledgment packet. In some examples, the AMP packet includes an AMP acknowledgement packet configured to request the response packet.

In some examples, the AMP packet includes a request for scheduling information, a request for energy harvesting capability information, or both. In some examples, the AMP packet includes a request for identifier information associated with the wireless device.

In some examples, the AMP Ack packet manager 608 is configurable or configured to transmit a second response packet prior to receiving the AMP acknowledgement packet, where the AMP acknowledgement packet is received based on the second response packet. In some examples, the response packet includes additional signaling associated with at least one of wireless device charging, one or more AMP trigger packets, instructions relating to additional communications, or any combination thereof.

In some examples, the AMP acknowledgment packet includes the receiver identifier and omits the transmitter identifier. In some examples, the AMP acknowledgement packet includes wakeup information associated with activating one or more radios of the wireless device. In some examples, the AMP acknowledgement packet includes a payload field indicating at least one of data, control information, management information, or any combination thereof.

FIG. 7 shows a flowchart illustrating an example process 700 performable by or at a wireless device that supports ambient power device frames for wireless communications. The operations of the process 700 may be implemented by a wireless device or its components as described herein. For example, the process 700 may be performed by a wireless communication device, such as the wireless communication device 600 described with reference to FIG. 6, operating as or within a wireless AP or a wireless STA. In some examples, the process 700 may be performed by a wireless AP or a wireless STA, such as one of the APs 102 or the STAs 104 described with reference to FIG. 1.

In some examples, in 702, the wireless device may receive a packet that includes a set of multiple fields, where one or more fields in the set of multiple fields includes information that identifies the packet as an AMP packet and identifies at least one of a transmitter identifier, receiver identifier, or both, and where AMP packets are associated with wireless communications by wireless devices using ambient power. The operations of 702 may be performed in accordance with examples as disclosed herein. In some implementations, aspects of the operations of 702 may be performed by an AMP packet manager 604 as described with reference to FIG. 6.

In some examples, in 704, the wireless device may transmit a response packet associated with the AMP packet. The operations of 704 may be performed in accordance with examples as disclosed herein. In some implementations, aspects of the operations of 704 may be performed by a response packet manager 606 as described with reference to FIG. 6.

FIG. 8 shows a flowchart illustrating an example process 800 performable by or at a wireless device that supports ambient power device frames for wireless communications. The operations of the process 800 may be implemented by a wireless device or its components as described herein. For example, the process 800 may be performed by a wireless communication device, such as the wireless communication device 600 described with reference to FIG. 6, operating as or within a wireless AP or a wireless STA. In some examples, the process 800 may be performed by a wireless AP or a wireless STA, such as one of the APs 102 or the STAs 104 described with reference to FIG. 1.

In some examples, in 802, the AP may transmit, to a wireless device, a packet that includes a set of multiple fields, where one or more fields in the set of multiple fields includes information that identifies the packet as an AMP packet and identifies at least one of a transmitter identifier, receiver identifier, or both, and where AMP packets are associated with wireless communications by wireless devices using ambient power. The operations of 802 may be performed in accordance with examples as disclosed herein. In some implementations, aspects of the operations of 802 may be performed by an AMP packet manager 604 as described with reference to FIG. 6.

In some examples, in 804, the AP may receive, from the wireless device, a response packet associated with the AMP packet. The operations of 804 may be performed in accordance with examples as disclosed herein. In some implementations, aspects of the operations of 804 may be performed by a response packet manager 606 as described with reference to FIG. 6.

Implementation examples are described in the following numbered clauses:

The following provides an overview of aspects of the present disclosure:

Aspect 1: A method for wireless communications at a wireless device, comprising: receiving, at the wireless device, a packet that comprises a plurality of fields, wherein one or more fields in the plurality of fields comprises information that identifies the packet as an AMP packet and identifies at least one of a transmitter identifier, receiver identifier, or both, and wherein AMP packets are associated with wireless communications by wireless devices using ambient power; and transmitting, by the wireless device, a response packet associated with the AMP packet.

Aspect 2: The method of aspect 1, wherein the one or more fields comprise information identifying an AMP packet type associated with the AMP packet, the AMP packet type comprising at least one of an AMP trigger packet or an AMP acknowledgement packet.

Aspect 3: The method of any of aspects 1 through 2, wherein the AMP packet comprises an AMP trigger packet configured to request the response packet.

Aspect 4: The method of aspect 3, wherein the AMP trigger packet comprises a bitmap that is set to a value to request the response packet, the response packet is transmitted according to the value.

Aspect 5: The method of any of aspects 3 through 4, wherein the AMP packet comprises both the transmitter identifier and the receiver identifier.

Aspect 6: The method of any of aspects 3 through 5, wherein the AMP packet comprises access policy and distribution information associated with time resources, frequency resources, or both, for the response packet.

Aspect 7: The method of any of aspects 3 through 6, wherein the response packet comprises an AMP acknowledgment packet.

Aspect 8: The method of any of aspects 1 through 7, wherein the AMP packet comprises an AMP acknowledgement packet configured to request the response packet.

Aspect 9: The method of aspect 8, further comprising: transmitting a second response packet prior to receiving the AMP acknowledgement packet, wherein the AMP acknowledgement packet is received based at least in part on the second response packet.

Aspect 10: The method of any of aspects 8 through 9, wherein the response packet comprises additional signaling associated with at least one of wireless device charging, one or more AMP trigger packets, instructions relating to additional communications, or any combination thereof.

Aspect 11: The method of any of aspects 8 through 10, wherein the AMP acknowledgment packet comprises the receiver identifier and omits the transmitter identifier.

Aspect 12: The method of any of aspects 8 through 11, wherein the AMP acknowledgement packet comprises wakeup information associated with activating one or more radios of the wireless device.

Aspect 13: The method of any of aspects 8 through 12, wherein the AMP acknowledgement packet comprises a payload field indicating at least one of data, control information, management information, or any combination thereof.

Aspect 14: The method of any of aspects 1 through 13, wherein the AMP packet comprises a request for scheduling information, a request for energy harvesting capability information, or both.

Aspect 15: The method of any of aspects 1 through 14, wherein the AMP packet comprises a request for identifier information associated with the wireless device.

Aspect 16: A wireless device for wireless communications, comprising one or more memories storing processor-executable code, and one or more processors coupled with the one or more memories and individually or collectively operable to execute the code to cause the wireless device to perform a method of any of aspects 1 through 15.

Aspect 17: A wireless device for wireless communications, comprising at least one means for performing a method of any of aspects 1 through 15.

Aspect 18: A non-transitory computer-readable medium storing code for wireless communications, the code comprising instructions executable by one or more processors to perform a method of any of aspects 1 through 15.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A wireless device, comprising:
a processing system that includes processor circuitry and memory circuitry that stores code, the processing system configured to cause the wireless device to:
receive, at the wireless device, a packet that comprises a plurality of fields, wherein one or more fields in the plurality of fields comprises information that identifies the packet as an ambient power (AMP) packet and identifies at least one of a transmitter identifier, receiver identifier, or both, and wherein AMP packets are associated with wireless communications by wireless devices using ambient power; and
transmit, by the wireless device, a response packet associated with the AMP packet.

2. The wireless device of claim 1, wherein the one or more fields comprise information identifying an AMP packet type associated with the AMP packet, the AMP packet type comprising at least one of an AMP trigger packet or an AMP acknowledgement packet.

3. The wireless device of claim 1, wherein the AMP packet comprises an AMP trigger packet configured to request the response packet.

4. The wireless device of claim 3, wherein:
the AMP trigger packet comprises a bitmap that is set to a value to request the response packet, and
the response packet is transmitted according to the value.

5. The wireless device of claim 3, wherein the AMP packet comprises both the transmitter identifier and the receiver identifier.

6. The wireless device of claim 3, wherein the AMP packet comprises access policy and distribution information associated with time resources, frequency resources, or both, for the response packet.

7. The wireless device of claim 3, wherein the response packet comprises an AMP acknowledgment packet.

8. The wireless device of claim 1, wherein the AMP packet comprises an AMP acknowledgement packet configured to request the response packet.

9. The wireless device of claim 8, wherein the processing system is further configured to cause the wireless device to:
transmit a second response packet prior to receiving the packet, wherein the packet is received based at least in part on the second response packet.

10. The wireless device of claim 8, wherein the response packet comprises additional signaling associated with at least one of wireless device charging, one or more AMP trigger packets, instructions relating to additional communications, or any combination thereof.

11. The wireless device of claim 8, wherein the AMP acknowledgment packet comprises the receiver identifier and omits the transmitter identifier.

12. The wireless device of claim 8, wherein the AMP acknowledgement packet comprises wakeup information associated with activating one or more radios of the wireless device.

13. The wireless device of claim 8, wherein the AMP acknowledgement packet comprises a payload field indicating at least one of data, control information, management information, or any combination thereof.

14. The wireless device of claim 1, wherein the AMP packet comprises a request for scheduling information, a request for energy harvesting capability information, or both.

15. The wireless device of claim 1, wherein the AMP packet comprises a request for identifier information associated with the wireless device.

16. The wireless device of claim 1, wherein the wireless device comprises an AMP device.

17. A method for wireless communications at a wireless device, comprising:
receiving, at the wireless device, a packet that comprises a plurality of fields, wherein one or more fields in the plurality of fields comprises information that identifies the packet as an ambient power (AMP) packet and identifies at least one of a transmitter identifier, receiver identifier, or both, and wherein AMP packets are associated with wireless communications by wireless devices using ambient power; and
transmitting, by the wireless device, a response packet associated with the AMP packet.

18. The method of claim 17, wherein the one or more fields comprise information identifying an AMP packet type associated with the AMP packet, the AMP packet type comprising at least one of an AMP trigger packet or an AMP acknowledgement packet.

19. An access point (AP), comprising:
a processing system that includes processor circuitry and memory circuitry that stores code, the processing system configured to cause the AP to:
transmit, to a wireless device, a packet that comprises a plurality of fields, wherein one or more fields in the plurality of fields comprises information that identifies the packet as an ambient power (AMP) packet and identifies at least one of a transmitter identifier, a receiver identifier, or both, and wherein AMP packets are associated with wireless communications by wireless devices using ambient power; and
receive, from the wireless device, a response packet associated with the AMP packet.

20. The AP of claim 19, wherein the processing system is further configured to cause the AP to:
receive, from the wireless device, a second response packet prior to transmitting the packet, wherein the AMP packet is transmitted based at least in part on the second response packet
